(19) United States
(12) Patent Application Publication
(10) Pub. No.: US 2013/0024813 A1
(43) Pub. Date: Jan. 24, 2013

(54) METHOD, SYSTEM, AND MEANS FOR EXPRESSING RELATIVE SENTIMENTS TOWARDS SUBJECTS AND OBJECTS IN AN ONLINE ENVIRONMENT

(71) Applicants: William S. Schnorr, Manhattan Beach, CA (US); John V. Ward, Redondo Beach, CA (US)

(72) Inventors: William S. Schnorr, Manhattan Beach, CA (US); John V. Ward, Redondo Beach, CA (US)

(21) Appl. No.: 13/549,356

(22) Filed: Jul. 13, 2012

Related U.S. Application Data
(60) Provisional application No. 61/508,716, filed on Jul. 18, 2011.

(51) Int. Cl. G06F 3/048

(52) U.S. Cl. 715/810

(57) ABSTRACT

The present invention relates to rating and ranking relative passions for subjects and objects using an electronic device connected to the internet.

### CROSS-REFERENCE TO RELATED APPLICATIONS

This nonprovisional utility patent application claims the benefit of provisional patent application No. 61/508,716 with priority date of Jul. 18, 2011, which is incorporated herein in its entirety by reference.

### FIELD OF THE INVENTION

The present invention relates to rating and ranking relative passions for subjects and objects using an electronic device connected to the internet.

### BACKGROUND OF THE INVENTION

Prioritizing is one the most important basic tasks and challenges of human existence. Most typically it involves making decisions within the constraints of limited money and limited time. Budgeting money and time intelligently is often difficult and time consuming. On a personal level, prioritizing comes down to understanding and organizing one's sentiments. Things for which a person has affinity or passion will typically be allocated more time and money than things for which a person has few feelings.

“Organizing” one's feelings can be difficult, and there are industries and activities dedicated to helping people, and companies, figure out what is important to them. From psychology to self-help literature, to questionnaires, personality tests, and budgeting software, there exist extensive tools people can use to try to sort out their preferences. Many firms perform matrix analyses in efforts to establish the relative merits of contemplated products or divine market opportunities.

The fundamental difficulty with all budgeting is limited resources. There is typically not enough time or money available. Because of this people are forced to evaluate relative importance. This evaluation process can be challenging, and many complicated processes and “N step methods” have been devised to help people with this task.

Related to this is the act of expressing opinions on various subjects, which is a fundamental part of the human experience. One's feelings and opinions underpin how one prioritizes and makes decisions. In this regard, opinion polls typically do not provide a good way to distinguish the relative passion for multiple subjects, or the relative passion between multiple users. In simple, but not necessarily of minor importance, two fans hate Yankees baseball, and both might rate their dislike at 10 on a scale of 1 to 10. However, such a vote provides no information about the relative level of passion between the two voters because they were not constrained by competing priorities. If they both also hate Raiders football, they would have to consider how to allocate their hate across Yankees baseball and Raiders football in order to get a more meaningful comparison between the passion levels of the two fans. Any hatred allocated to Yankees baseball, can in this case not be allocated to Raiders football, forcing the fans to consider where their passions truly lie.

The present invention provides the users with a voting budget. Instead of voting singularly on issues one by one, voters are given an allocation of points, typically one hundred, which they must distribute among a predetermined list according to their passions. In the case of sports for instance, a fan may spend 63 “hate” points on Raiders football, 19 on Chelsea soccer, and 18 on Duke Blue Devils basketball, while another fan may spend 56 on Raiders football, 34 on Yankees baseball, and 10 on Maple Leafs hockey. Even though both fans “hate” Raiders football the most of any team, the first fan could claim to be the more passionate Raider hater because she has used up more of her budget on the Raiders.

Accordingly, the present invention affords people a simple and fun technique for establishing and displaying to others their relative sentiments for various subjects and objects. It also helps people examine and sort out their true priorities. Specifically, the present invention provides a method, system, and means for expressing relative sentiments towards subjects and objects in an online environment.

### SUMMARY OF THE INVENTION

A software application with a graphical user interface which provides users with a voting budget which can be spent voting on subjects or objects, such as the like or dislike of certain sports teams, players, celebrities, politicians, etc. In the context of its basic method, the present invention's most basic embodiment comprises software programs, applications, clients and engines, especially in connection with internet-based environments, providing user interfaces accessible by computer, tablet, cell phone, or other stationary or mobile internet-enabled device.

### DESCRIPTION OF THE DRAWINGS

FIGS. 1 and 2 show the home page of the preferred embodiment of the present invention.

FIG. 3 shows the team selection page of the preferred embodiment of the present invention.

FIG. 4 presents an example page intended to guide a user in use of the present invention.

FIG. 5 illustrates the hate points allocation page where a user allocates 100 points to selected teams.

FIGS. 6 and 7 show a worldwide ranking page which lists aggregated passion points teams have received from multiple users.

FIG. 8 presents a “hate curve” which monitors dynamic variations in how much a team is hated by the community of users.

FIG. 9 shows the sport selection page of a second example of the present invention.

FIG. 10 shows the team selection page of a second example of the present invention, where the user can select either love or hate.

FIG. 11 shows the point allocation page of a second example of the present invention, where the user can allocate core and flex points for teams on their love and hate lists.

FIG. 12 illustrates the second example of the present invention providing constructive guidance to the user.

FIG. 13 shows the final user love or hate list of a second example of the present invention.

FIG. 14 illustrates the second example of the present invention providing assistance to the user for them to share their love or hate lists over the internet.

FIG. 15 shows an alternate means in a second example of the present invention for the user to search for and select teams.

FIG. 16 shows how a second example of the present invention presents aggregate user data to the user.

FIG. 17 shows how a second example of the present invention provides detailed information on the aggregate data for a particular team.

FIG. 18 shows how a second example of the present invention assists the user to tell others about the present invention via email.

FIG. 19 shows a block diagram of the computer system for the present invention.

### DETAILED DESCRIPTION OF THE INVENTION

The following description illustrates the invention by way of example, not by way of limitation of the principles of the invention. This description will enable one skilled in the art to make and use the invention, and describes several embodiments, adaptations, variations, alternatives and uses of the invention, including what we presently believe is the best mode of carrying out the invention.

Prior art. Voting and polling via the internet allows users to express their opinions about various subjects. For example, the website www.hotornot.com provides a simple interface where users can click to rate the attractiveness of people based on pictures and also get feedback about what others users have voted. Other websites such as www.rottentomatoes.com provide similar interactiveness where users can vote on their like or dislike of movies, as does the iTunes “Tomato meter”, etc.

Embodiment. In the context of its basic method, the present invention's most basic embodiment is software programs, applications, and engines, providing user interfaces accessible by computer, tablet, cell phone, or other mobile device.

The preferred embodiment of the present invention will be described by way of an example wherein a user registers for an account and allocates votes according to relative passions for sports teams.

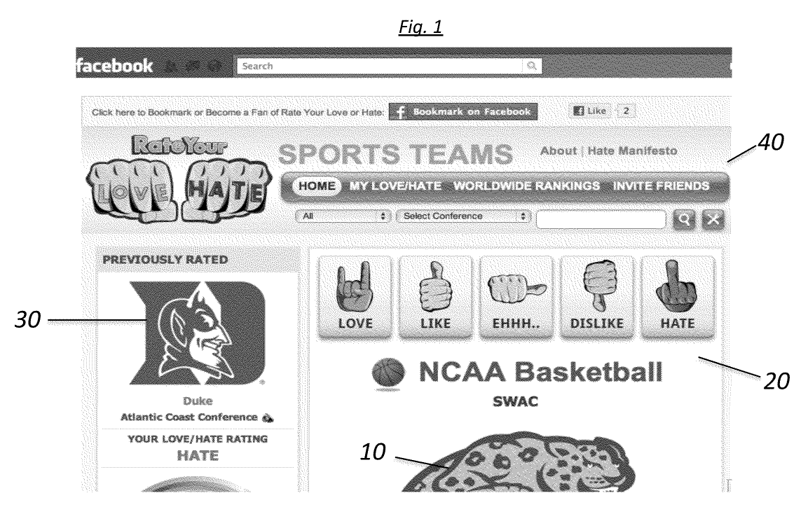

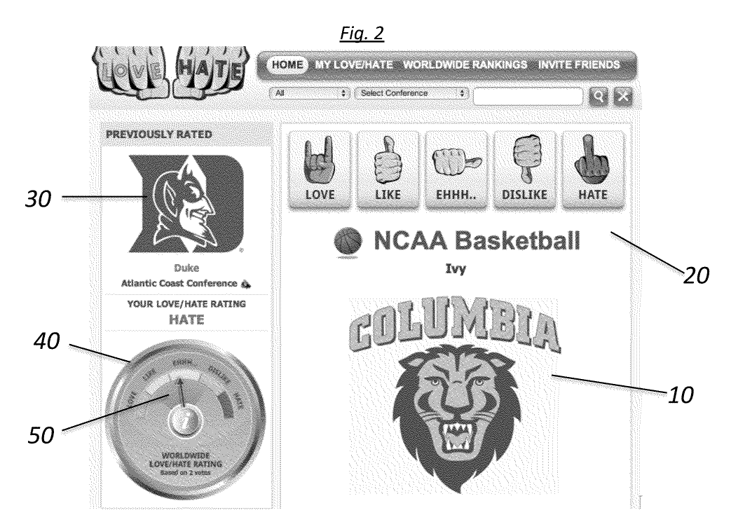

Referring now to the drawings, in which like reference numbers represent similar or identical structures throughout, FIGS. 1 and 2 show the homepage of a website according the preferred embodiment of the present invention, which is a Facebook application. This homepage shows a series of icons which help the user understand and navigate the site. One such icon 10 symbolizes a specific object or subject such as a sports team. A series of virtual buttons 20 which can be “pressed” or clicked allow the user to rate her passion for the team displayed. Another icon 30 symbolizes a team previously rated. A so-called hate-meter 40 provides a graphical indication of how the current team at hand has been rated and also provides a range 50 indicating how passionately other users feel about said team. A very wide such range 50 indicates that there is a large statistical variance in how users feel about that team and thus telegraphs that the team generates strong feelings of both love and hate in people, as opposed to a team which might be “mono-emotional” and only elicit a narrow range of emotional response. Also shown are a series of links 60 which lead the user to other pages of the site.

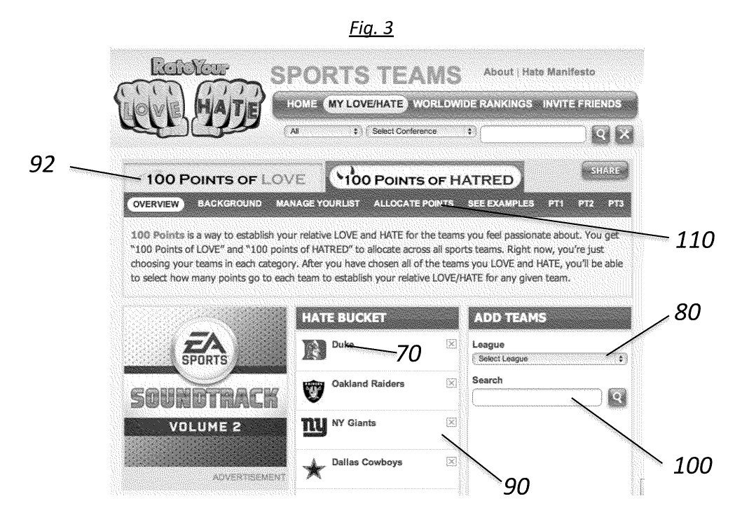

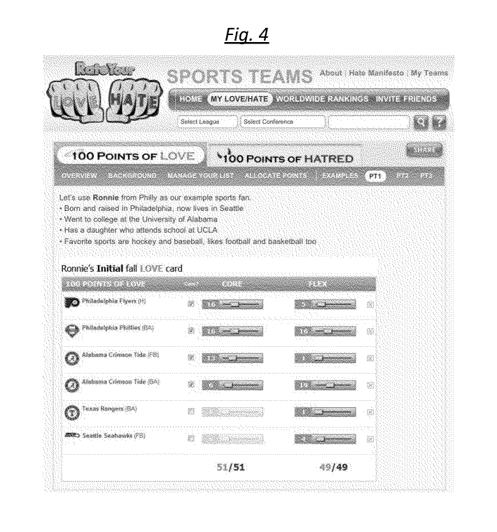

FIG. 3 shows one such page, where the user can select teams which are disliked or hated 70 from a drop-down menu 80 and thus list them in a list 90 (an equivalent page exists for teams which are liked or loved and can be accessed through the link 92). The drop-down menu 80 makes searching for teams simple by listing teams according to sports categories, leagues, conferences, etc. A direct search for a team is also possible through a search box 100. Once the user is satisfied that her team list 90 is complete, she can move on to allocating one hundred points of “hate” (or love) to her selected teams by clicking the link 110. If the user feels especially passionate, it is possible to amplify the hundred points voting budget by earning (or buying, for amounts small enough not to give people with higher purchasing power an advantage) a passion multiplier (not shown). This may be particularly interesting during high profile tournaments like March Madness or the FIFA World Cup when users might want to increase the weight of their passion relative to other users. This amplifier would not disrupt or occlude the basic hundred total points accorded any user, but it could provide a method to determine who is the “world's greatest fan” or the “most hated team in the US”, etc.

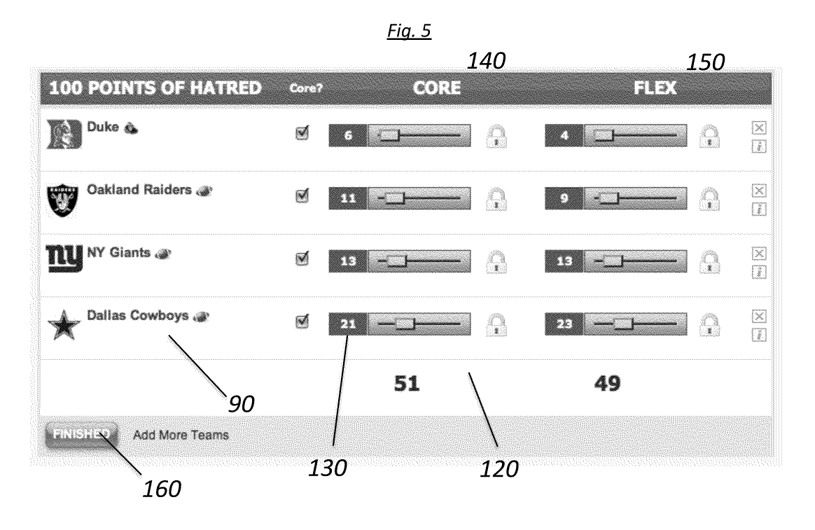

The allocation of the hundred passion points, “hate points” in this example, to the selected teams 90 is done through the graphical user interface presented in FIG. 5. By adjusting a series of sliders 120 the user can allocate hate points 130 which are updated and displayed dynamically as the sliders 120 are adjusted, providing real-time visual feedback to the user. The hundred passion points are divided into the categories of core 140 and flex 150, where core point allocations, which must add up to a total of fifty-one, cannot be changed later, and flex point allocations, which must add up to forty-nine, can be adjusted as often as the user desires. Core points represent core feelings which do not change much with time. Examples of such feelings might be native love of certain colors or foods, or in this case ongoing hate of a rival team. Flex points represent adjustable passions, such as support for the football team of a school where one just enrolled, etc. The user adjusts the sliders 120 until all the core and flex points have been allocated and finalizes her breakdown of relative passions for the listed teams 90 by way of a button 160.

The allocation process can occur in multiple ways. In one embodiment, if the inputs sum to more or less than one hundred points, the discrepancy is displayed and the application graphically instructs the user to adjust the allocation until the total is one hundred. In another embodiment, the user might initially input a random number for a team and then as the allocation process progressed, the application would automatically normalize the distribution of points to a scale of 1-100 (or other scale deemed suitable). This has the advantage that the user might have an easier time starting the allocation process because she thus can pick any starting point. All subsequent numbers will then be relative to this first number, and this is useful for some people as they may not know how much they hate the Raiders on a particular scale, but they may know that they hate them more than they hate the Yankees, and less than they hate Chelsea. “Head-to-head”voting in this manner, with automatic normalization to a scale of 1-100, as all the teams in the list 90 are sequentially considered is the simplest allocation process for some users. In yet another embodiment, the voting budget of one hundred points is initially distributed as evenly as possible across the selected teams 90, thus providing starting allocations for each team. This can make voting easier as the user simply has to nudge team allocations up or down from an initial reference number depending on the user's relative passion for the teams.

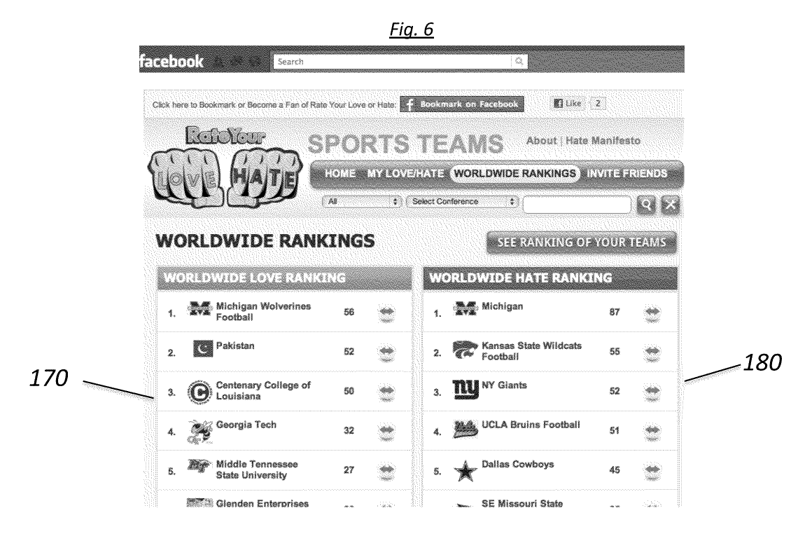

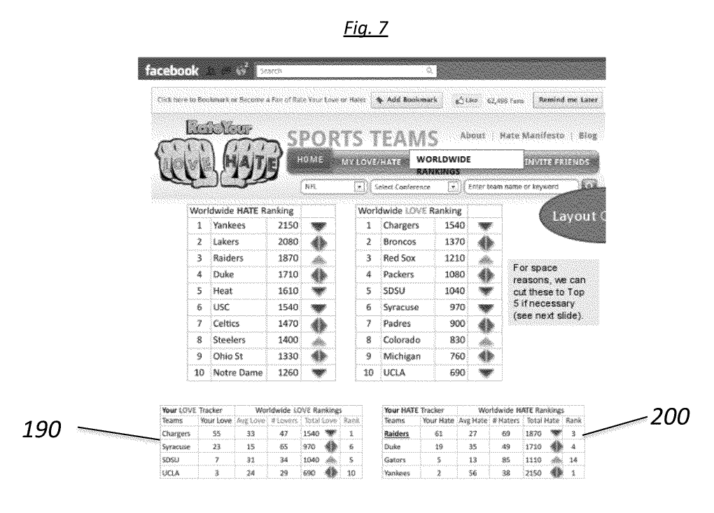

The relative passions of multiple users for various teams are aggregated and presented in worldwide ranking love and hate lists 170, 180, as shown in FIG. 6. The lists 170, 180 give feedback to the user about how other users feel about various teams. FIG. 7 shows a furthering of this idea where tables 190, 200 compare the user's allocations to those of other users. It is further possible to compare allocations between multiple users such that users with similar allocations, or “love/hate profiles”, can befriend each other in much the same way as one would “friend” people on Facebook, or compare profiles on dating sites such as Match.com or eHarmony.com in an effort to find overlapping interests.

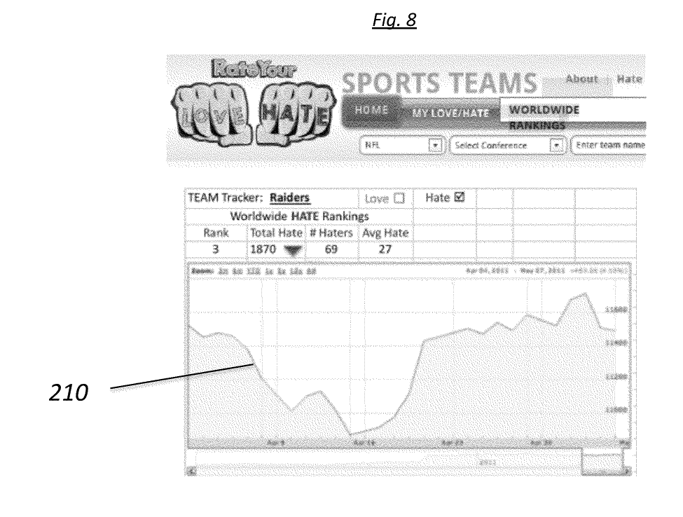

Aggregated allocations over many users also make it possible to provide a worldwide tracker (FIG. 8), which much like a real-time stock price chart show how the “hate curve” 210 (or love curve) of a team or player dynamically changes with daily events, such as a match-fixing scandal, or unsportsmanlike conduct, etc. This curve can be particularly interesting to following during big games or tournaments as stories develop and spectator passions run high.

This technique of using graphs to index or track running passions can also be used to track how an individual user's sentiments might evolve over time. For sports or beyond sports, a user might look at her “passion history”, as captured graphically, to see how feelings might have changed over time on various subjects, much like a stock price might change over time.

Other features of the present invention include facilities for users to dynamically suggest subjects on which to vote to the online community.

The invention also allows for a series of statistical computations to be done on users' stored points allocations, in much the same way as statistics can brought to bear on collected data for the purposes of understanding trends, correlations, similarities, differences, shared or differing views, and collective opinions.

Accordingly, the present invention provides a method, system, and means for expressing relative sentiments towards subjects and objects in an online environment.

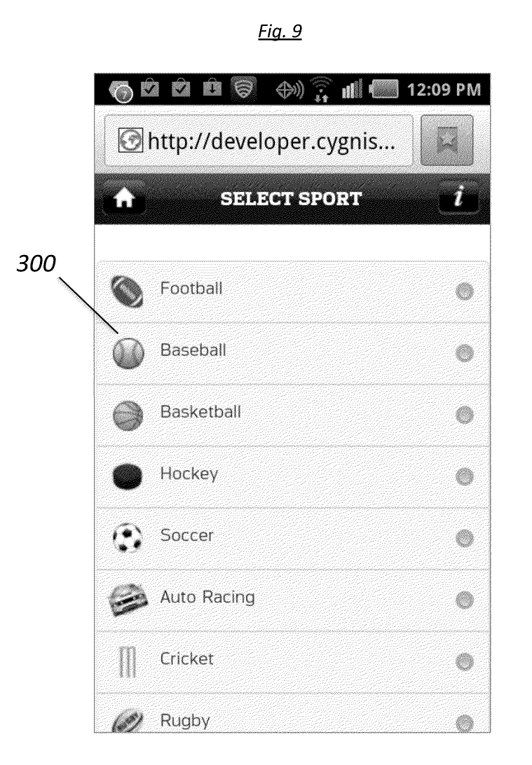

In a second example, beginning with FIG. 9, the user is presented with an invention interface designed to allow the user to select a sport 300 of the user's choosing, in which the user has passionate opinions of fandom. From this screen, the user is then presented with options via the interface for selecting various leagues, divisions and/or conferences. By inputting the selections, the user commands the invention to display teams from which the user can select.

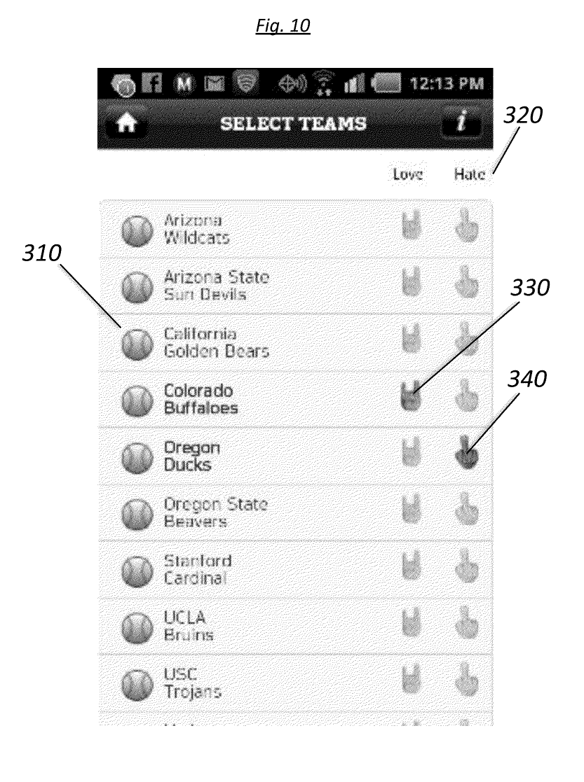

In FIG. 10, once the user chooses a sport and a league, division, and/or conference, the invention presents the user with a list of associated teams 310. Through input with the invention interface, the user designates certain teams (i.e., those the user feels passionately about) as being in either the “Love” or the “Hate” category 320 by touching on the appropriate hand signal, “Love” 330 and “Hate” 340. The user submits this data and it is recorded and tabulated by the invention.

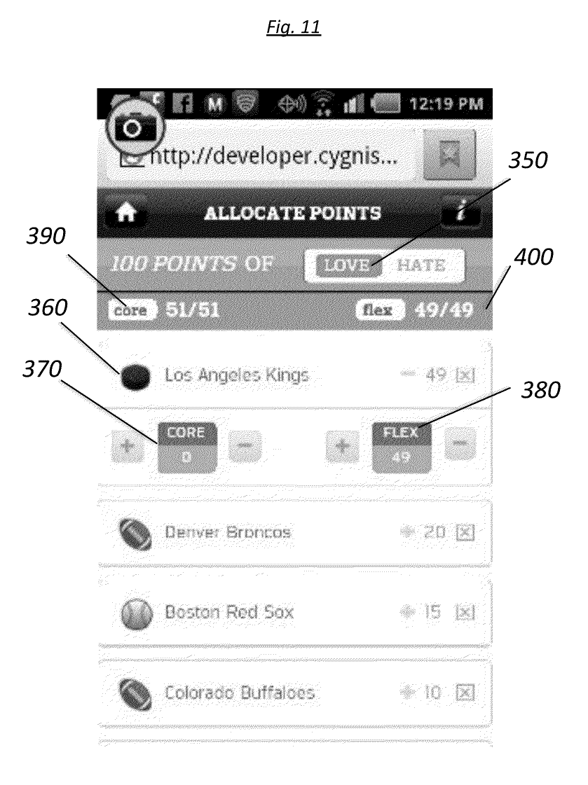

In FIG. 11, once the user has designated all of the appropriate teams as “Love” or “Hate,” the invention presents the user with a list of those teams segregated by category 350. By using the invention's interface, the user begins to apply point values to each team 360 corresponding to the level of Love or Hate that the user holds for that team. The Love and Hate categories are divided into two distinct concepts: Core 370 and Flex 380. Core Love and Core Hate 390 each comprise 51 percent of the user's total allocation of 100 Points and is registered by the invention and not subject to change. Flex Love and Flex Hate 400 each comprise 49 percent of the user's total allocation of 100 Points and can be changed at any time based upon the whims and seasonal patterns of the user's fandom and passion.

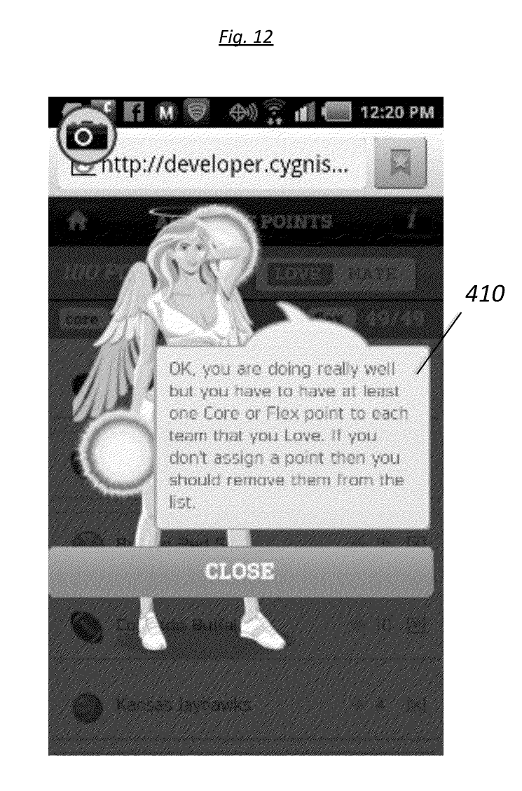

In FIG. 12, the invention requires the user to strictly adhere to the 51 Core and 49 Flex requirement. Should the user attempt to circumvent this, the invention provides an avatar reminder 410 via the interface to remind the user of the rules and suggest the necessary modifications.

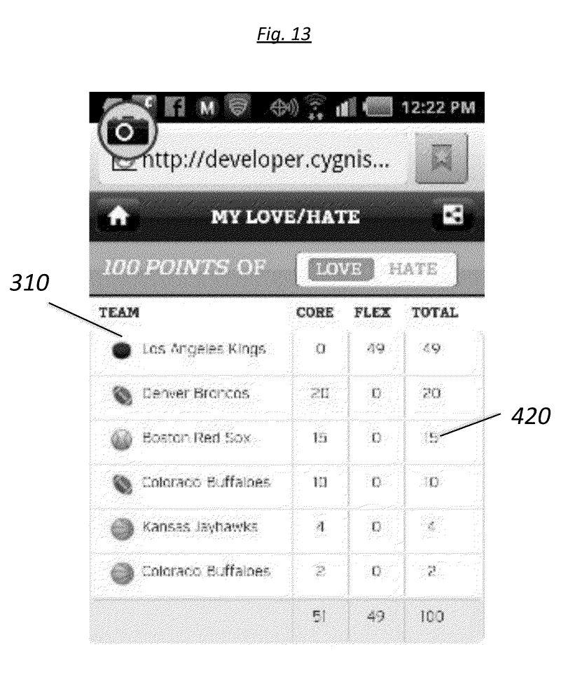

In FIG. 13, once the user has correctly set and submitted the proscribed point allocation, the invention records and tabulates the results, and displays them to the user via the interface. The point totals 420 for the various teams 310 are stored by the invention's database and are subject to further revision according to the rules of the Core and Flex allocation. The user can return to these results at any time by accessing the user's account on a computer device through the previously-created login.

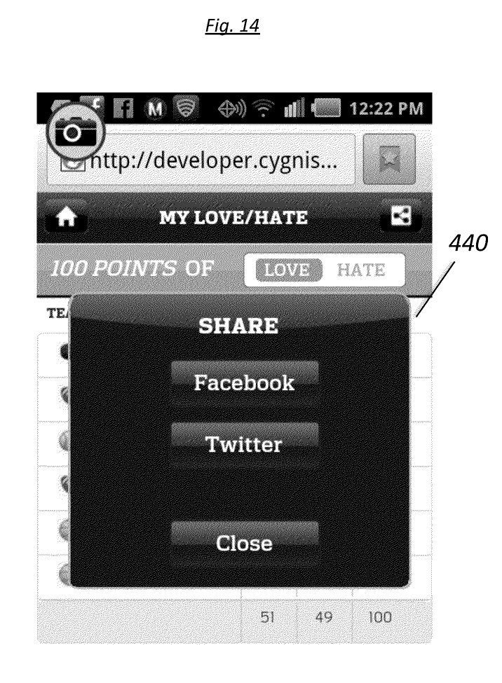

In FIG. 14, the user can share results with various social media outlets. The invention provides an interface 440 for the user to quickly and easily post results.

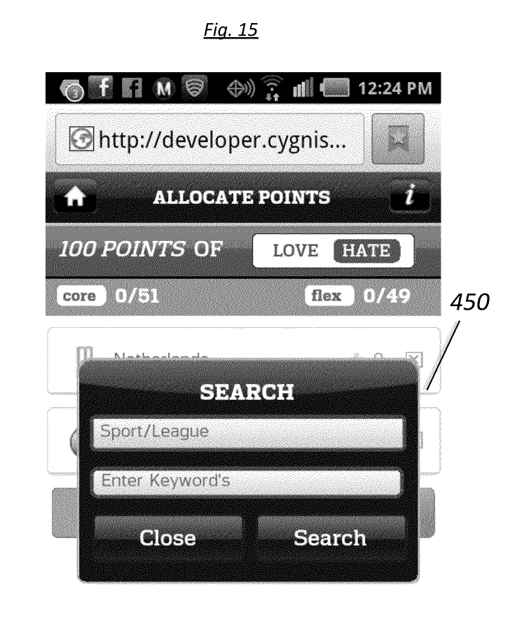

In FIG. 15, to facilitate revision of a user's list, the invention includes a search engine 450 which takes user input and matches it with entries from the invention's team database. This part of the interface provides a faster method for the user to focus in on key subjects.

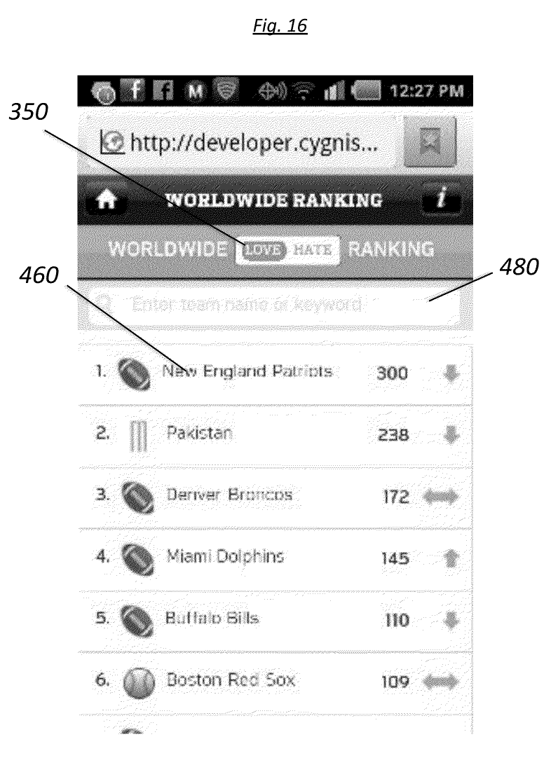

FIG. 16 shows the result of the invention compiling all user data, running it through statistical analysis, then ranking, tabulating, and presenting the up-to-date data via the interface. Lists of the most Loved and the most Hated teams 460 can be summoned by the user from the invention via the interface 350. The user may also search for a team outside the most loved or hated by inputting the team name into the Search field 480 and requesting that record.

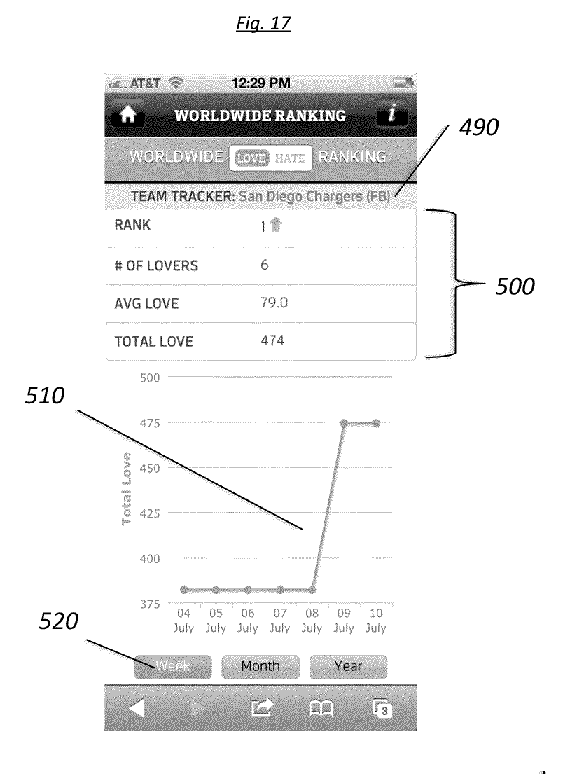

In FIG. 17, by selecting a particular team 490 via the interface of FIG. 16, the invention searches the database to display the statistical analysis of all user submissions for that team. The relevant data is displayed numerically 500 and graphically 510, and the user is given the option to view data over multiple time periods 520.

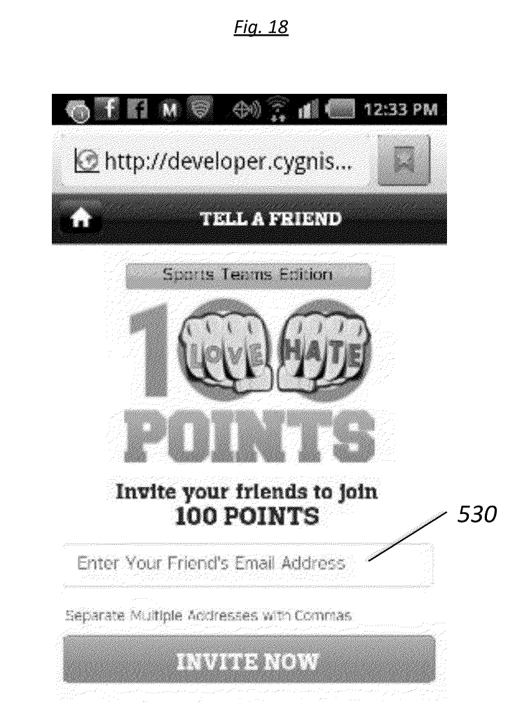

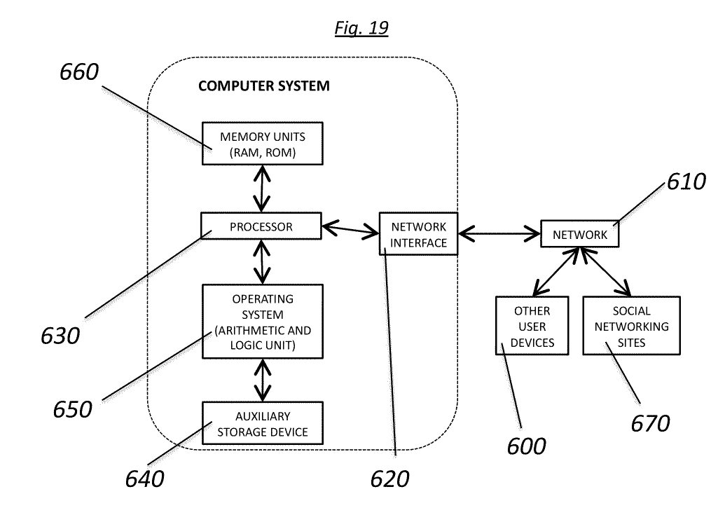

In FIG. 18, the invention allows the user to inform friends and invite them to use the invention to create lists of their own. The interface provides a user input for email addresses 530 which causes the invention to generate an automated email message informing the recipient of the invention and inviting them to create an account of their own.

The internet site and its webpages as described above are hosted and stored on a (remote) computer system or server accessible via a Network (such as the Internet), as shown in FIG. 9. The user device 600 transmits in put via the Network 610 into the Network Interface 620. The Network Interface 620 transmits user input to the Processor 630, which runs the programs comprising the system. An Auxillary Storage Device 640 stores indicators or pointers for a number of different sports and sports teams. The processor 630 accesses the Auxillary Storage Device 640 by way of an Operating System 650 and displays the names of sports or teams in said Network Interface 620. The Network Interface 620 allows a user to select teams among the various sports by way of Other User Devices 600 such as keyboard, mouse, joystick, voice, or touchscreen, prompting the Processor 630 to access the Memory Unit 660 and retrieve data representing the user's selections and store that user's particular selections in a section of the Memory Unit 660.

Once selections have been made, the Processor 630 and Network Interface 620 provides the user with a second input routine which lets the user allocate one hundred points (or similar) across her selections. The Memory Unit 660 captures and stores the allocations which are then displayed graphically through the Network Interface 620 to a User Device 600 or a Social Networking Site 670, both of which are connected to the Network 610. The Processor 630 receives the user input and stores it in the Memory Unit 660. The processes described above, comprising user input; reading and writing to memory; data-base management of user accounts; rendering, displaying, and updating of graphics; computations related to points allocations and statistics across multiple users; etc, are controlled by a Processor 630.

The present invention has been described above in terms of a presently preferred embodiment so that an understanding of the present invention can be conveyed. However, many alternative ways of constructing the website, software engine, and internet systems are possible without departing from the principle of the invention. The scope of the present invention should therefore not be limited by the embodiments illustrated, but rather it should be understood that the present invention has wide applicability with respect to its stated objectives. For example, the present invention extends to any subject matter about which people might have opinions or feelings, including movies, books, music, politics, people, etc. All modifications, variations, or equivalent elements and implementations should therefore be considered within the scope of the invention.

Variations and modifications of the foregoing are within the scope of the present invention. For example, one of skill in the art will understand that the invention can be practiced on multiple devices or a single device. The present invention is therefore not to be limited to the system depicted in the figures as the system is simply illustrative of the features, teachings, and principles of the invention. It should further be understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention that will enable others skilled in the art to utilize the invention.

1. A method for using a computer device connected to the internet to track user preferences comprising:
receiving at the computer device an indication of a specification of a plurality of items from a predetermined list;
receiving at the computer device an indication of an allocation of values to each of said plurality of items, wherein said values correspond to either positive emotions or negative emotions,
determining at the computer device that the sum of the values allocated to each of said plurality of items is a predetermined total,
providing information for display on a remote graphical user interface regarding said plurality of items and said allocation of values; and
storing said allocation of values in a memory device.

2. The method of claim 1 wherein said predetermined total is 100 points.

3. The method of claim 1 wherein said positive emotion is designated “Love” and said negative emotion is designated “Hate.”

4. The method of claim 1 wherein said allocation of values comprises a first allocation of values and a second allocation of values, wherein said first allocation of values is fixed and unchangeable and said second allocation of values is changeable.

5. The method of claim 1 further comprising receiving at the computer device a second indication of a second specification of a second plurality of items from the predetermined list; receiving at the computer device a second indication of a second allocation of values to each of said second plurality of items, and comparing at the computer device the first allocation of values to the second allocation of values.

6. The method of claim 1 further comprising storing at the computer device an allocation history that identifies how user allocations have changed over time.

7. The method of claim 1 further comprising receiving at the computer device a second indication of a second specification of a second plurality of items from the predetermined list; receiving at the computer device a second indication of a second allocation of values to each of said second plurality of items, and aggregating at the computer device at least the first allocation and the second allocation to produce an aggregate allocation, and providing information for display on a remote graphical user interface regarding said aggregate allocation.

8. The method of claim 7 further comprising providing information for display on a remote graphical user interface regarding changes to the aggregate allocation over time.

9. The method of claim 1 further comprising determining at the computer device a mathematical relationship among the first allocation of values and the second allocation of values.

10. The method of claim 1 further comprising applying an amplifier to a plurality of the values allocated to a first subset of the plurality of items such that the plurality of values is more heavily weighted that a plurality of values allocated to a second subset of the plurality of items.

11. A system comprising a computer device connected to the internet for tracking user preferences and a non-transitory computer readable medium including instructions that when executed cause the computer device to perform:
prompting a user to select a subject from a predetermined list through a graphical user interface;
prompting the user to select items from a second predetermined list within said subject through said graphical user interface;
prompting the user to make an allocation of points to each of said items through said graphical user interface, wherein said allocation of points adds up to a predetermined total, and wherein said allocation of points comprises a first allocation of points and a second allocation of points, and wherein said first allocation of points is fixed and unchangeable and said second allocation of points is changeable.
providing information regarding said items and said allocation of points for display on a remote graphic user interface; and
storing said allocation of points on a memory device.

12. The system of claim 11 wherein said predetermined total is 100 points.

13. The system of claim 11 wherein said allocation of points to each of said items corresponds to either positive emotions (“Love”) or negative emotions (“Hate”).

14. The system of claim 11 further comprising comparing allocation profiles of two or more different users.

15. The software application of claim 11 further comprising creating an allocation history which shows the user how their allocations have changed over time.

16. The software application of claim 11 further comprising aggregating allocations across multiple users to produce an aggregate allocation containing all of the items aggregated from individual allocations with corresponding aggregate values, and displaying said aggregate allocation.

17. The software application of claim 11 further comprising aggregating allocations across multiple users to produce an aggregate allocation containing all of the items aggregated from individual allocations with corresponding aggregate values, and displaying said aggregate allocation graphically as it might change over time.

18. The software application of claim 11 further comprising performing mathematical analysis on allocations of at least two or more users.

19. The software application of claim 11 further comprising applying an amplifier to said allocation such that said allocation is more heavily weighted when compared to other allocations.

20. A fixed-preference and adjustable-preference allocation computer system comprising:
a processor;
a network interface; and
memory storing a plurality of individual fixed-preference budget allocations, a plurality of individual adjustable-preference budget allocations and computer readable instructions that, when executed by the processor, cause the computer system to perform:
receiving an indication of a security code,
providing to the user a first account balance of a fixed-preference budget,
providing to the user a second account balance of an adjustable-preference budget,
receiving via the network interface a plurality of indications of allocations of the first account balance to a first plurality of targets,
determining that the plurality of indications of allocations of the first account balance is equal to the fixed-preference budget,
locking the first account balance so that the allocation of the first account balance to the first plurality of targets is fixed and unchangeable by the user,
providing a notification to the user via the network interface that the first account balance has been exhausted,
providing a notification to the user via the network that the allocation of the first account balance is fixed and unchangeable by the user,
receiving via the network interface a second plurality of indications of allocations of the second account balance to a second plurality of targets,
determining that the second plurality of indications of allocations of the second account balance is equal to the adjustable-preference budget;
providing a notification to the user via the network interface that the second account balance has been exhausted;
providing a notification to the user via the network interface that the second account balance is not fixed and can be altered.
